(19) United States
(12) Patent Application Publication
(10) Pub. No.: US 2016/0157282 A1
(43) Pub. Date: Jun. 2, 2016

(54) Camera Controlled by Using a Smart Phone and Control System Thereof

(71) Applicant: CyWee System Ltd., Taipei City (TW)

(72) Inventor: Zhou Ye, Taipei (TW)

(21) Appl. No.: 14/569,847

(22) Filed: Dec. 15, 2014

(30) Foreign Application Priority Data
Dec. 2, 2014 (CN) 201410721040.5

(51) Int. Cl. H04W 76/02; H04M 1/02; H04N 5/232

(52) U.S. Cl. CPC H04W 76/023; H04N 5/23203; H04N 5/23216; H04M 1/0202

(57) ABSTRACT

A camera controlled by using a smart phone is provided. The camera includes a camera module, an encoder, and a wireless network module. The camera module is used for capturing an image. The encoder is coupled to the camera module, and is used for encoding the image according to a video coding scheme to generate an encoded image. The wireless network module is coupled to the encoder and wirelessly communicating with the smart phone directly, and is used for transmitting the encoded image to the smart phone to be displayed on the smart phone. The effect of low latency and low power consumption can be achieved during image transmission by using the video coding scheme, such that the battery life of the camera can be improved. By using the smart phone to control the camera, the size of the camera can be reduced. Therefore, the camera becomes more compact to be hung on glasses or hats to enable photography features for live records, and real-time images can be uploaded to cloud servers.

### BACKGROUND OF THE INVENTION

1. Field of the Invention

The present disclosure relates to a camera and its operating mode, and more particularly, to a camera controlled by using a smart phone and its control system thereof

2. Description of the Prior Art

At present, a conventional camera usually adopts a SD card as its storage, and the data transmission of such a camera is completed by removing the SD card or by connecting the camera with a computer via a data line to read the data of the camera. As a result, the goal of viewing the image and/or sharing the image to friends in real time cannot be achieved.

Additionally, the conventional camera currently uses a microprocessor with its encoding software to encode images, and its latency and power consumption will be a great challenge if a user wants to view the image and/or share the image to friends in real time.

Hence, how to overcome the design issue of the camera to make the images captured by the camera to be viewed and shared to friends in real time has become an important topic in this field.

### SUMMARY OF THE INVENTION

It is therefore one of the objectives of the present disclosure to provide a camera controlled by using a smart phone and its operating mode to solve the above-mentioned problems in the prior art. By using the smart phone to control the camera, the images can be viewed and shared to friends in real time.

According to one aspect of the present disclosure, a camera controlled by using a smart phone is provided. The camera includes a camera module, an encoder, and a wireless network module. The camera module is used for capturing an image. The encoder is coupled to the camera module, and is used for encoding the image according to a video coding scheme to generate an encoded image. The wireless network module is coupled to the encoder and wirelessly communicating with the smart phone directly, and is used for transmitting the encoded image to the smart phone to be displayed on the smart phone.

According to one aspect of the present disclosure, an interactive system using a smart phone to control a camera is provided. The interactive system includes a camera and a cloud server. The camera includes a camera module, an encoder, and a wireless network module. The camera module is used for capturing an image. The encoder is coupled to the camera module, and is used for encoding the image according to a video coding scheme to generate an encoded image. The wireless network module is coupled to the encoder and wirelessly communicating with the smart phone directly, and is used for transmitting the encoded image to the smart phone to be displayed on the smart phone. The smart phone stores the image to the cloud server through a private application programming interface, such that the image can be simultaneously viewed by lots of people.

According to one aspect of the present disclosure, an interactive system using a smart phone to control a camera is provided. The interactive system includes a camera, an access point, and a cloud server. The camera includes a camera module, an encoder, and a wireless network module. The camera module is used for capturing an image. The encoder is coupled to the camera module, and is used for encoding the image according to a video coding scheme to generate an encoded image. The wireless network module is coupled to the encoder and wirelessly communicating with the smart phone directly, and is used for transmitting the encoded image to the smart phone to be displayed on the smart phone. The smart phone stores the image to the cloud server through a private application programming interface, such that the image can be simultaneously viewed by lots of people. The wireless network module uses an AP mode for connecting with at least one smart phone. The advantage of the present disclosure is that the effect of low latency and low power consumption can be achieved during image transmission by using the video coding scheme, such that the battery life of the camera can be improved. By using the smart phone to control the camera, the size of the camera can be reduced. Therefore, the camera becomes more compact for convenient usage. Additionally, the smart phone can use the private application programming interface to store the image to the cloud server directly or via the smart phone, such that the image captured by the camera can be simultaneously viewed by lots of people.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram showing a camera controlled by using a smart phone according to an embodiment of the present disclosure.

FIG. 2 is a diagram illustrating an interactive system that using a smart phone to control a camera according to a first embodiment of the present disclosure.

FIG. 3 is a diagram illustrating an interactive system that using a smart phone to control a camera according to a second embodiment of the present disclosure.

FIG. 4 is a diagram illustrating an interactive system that using a smart phone to control a camera according to a third embodiment of the present invention.

FIG. 5 is a diagram illustrating a video coding scheme that adopts a slice-based encoding method according to an embodiment of the present disclosure.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”.

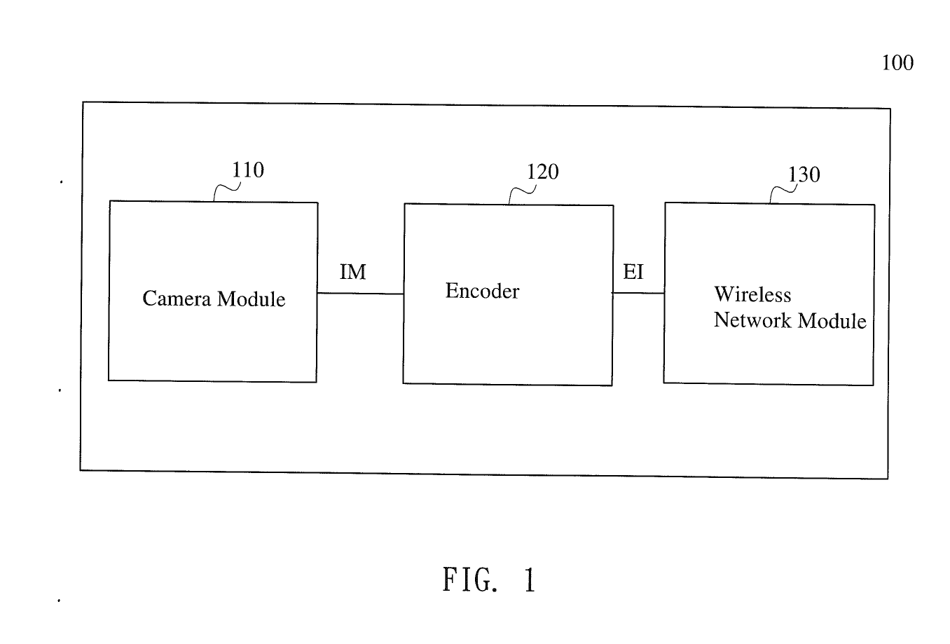

Please refer to FIG. 1. FIG. 1 is a block diagram showing a camera 100 controlled by using a smart phone according to an embodiment of the present disclosure. As shown in FIG. 1, the camera 100 may include a camera module 110, an encoder 120, and a wireless network module 130. The camera module 110 is used for capturing an image IM. The encoder 120 is coupled to the camera module 110, and is used for encoding the image IM according to a video coding scheme to generate an encoded image EI. Please note that, the video coding scheme adopts a slice-based encoding method for encoding the image IM so as to generate the encoded image EI. Herein the video coding scheme is compliance with H.264/AVC (Advanced Video Coding) video coding standard and H.265/HEVC (High Efficient Video Coding) video coding standard. Additionally, the wireless network module 130 is coupled to the encoder 120 and wirelessly communicating with a smart phone (not shown in FIG. 1), and is used for transmitting the encoded image EI to the smart phone to be displayed on the smart phone.

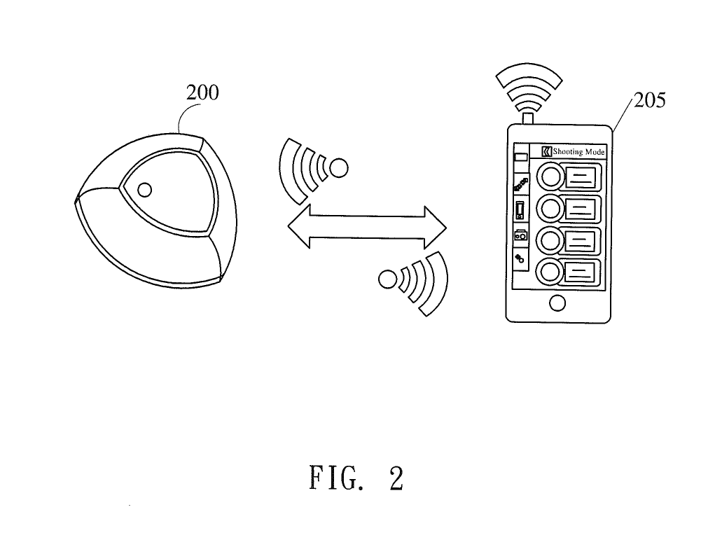

Please refer to FIG. 2. FIG. 2 is a diagram illustrating an interactive system that using a smart phone 205 to control a camera 200 according to a first embodiment of the present disclosure. Please note that, as shown in the embodiment of FIG. 2, the wireless network module 130 of the camera 200 can use Wi-Fi Direct technology for establishing a point-to-point connection with the smart phone 205, so as to achieve a two-way interaction. Additionally, the smart phone 205 may include a private application programming interface (API) for controlling the camera 200. The private application programming interface can be built-in software of the smart phone 205, or application software downloaded by a user himself, however, this should not be a limitation of the present disclosure. Any application programming interfaces that can achieve interactions between the smart phone 205 and the camera 200 are in compliance with the spirit of the present disclosure and fall within the scope of the present disclosure. What calls for special attention is that, in another embodiment of the present disclosure, the wireless network module 130 of the camera 200 may use an access point mode for establishing a point-to-point connection with the smart phone 205, so as to achieve a two-way interaction; or the wireless network module 130 of the camera 200 may use the access point mode for simultaneously connecting with a plurality of smart phones 205, respectively, such that the plurality of smart phones 205 can simultaneously view the image IM captured by the camera 200.

Please continue to refer to FIG. 2. In this embodiment, one user can use the private application programming interface of the smart phone 205 to generate a control signal to adjust parameters including white balance and/or photographic intensity of the camera module 110, if required. Additionally, in another embodiment of the present disclosure, the user can use the private application programming interface of the smart phone 205 to generate a control signal for controlling lens of the camera module 110 to zoom in or zoom out the image, if required. By using the private application programming interface of the smart phone 205 to control the camera 200, some components of the camera 200, such as, a shutter button, a display panel, and a touch screen, can be omitted. Therefore, the size of the camera 200 can be reduced so as to lower cost and weight, and thus the camera 200 can be hung on glasses, clothing, or hats to enable photography features for live records.

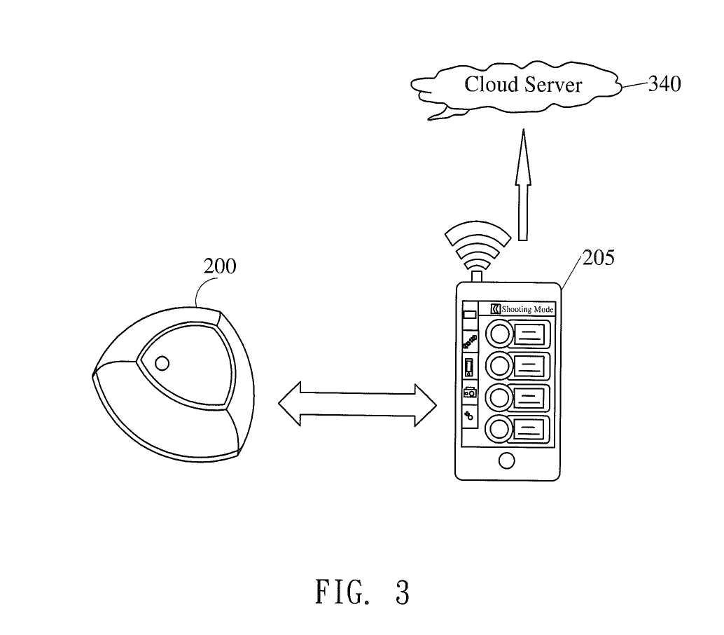

Please refer to FIG. 3. FIG. 3 is a diagram illustrating an interactive system that using a smart phone 205 to control a camera 200 according to a second embodiment of the present disclosure. The smart phone 205 uses the private application programming interface to store the image to a cloud server 340, such that the image can be simultaneously viewed by lots of people: Other people can use their smart phones, tablets, or computers for connecting to the cloud server 340 through network to simultaneously view the image captured by the camera 200. What calls for special attention is that, in this embodiment, the image captured by the camera 200 can be transmitted to the smart phone 205 via streaming in advance. After that, the smart phone 205 may transmit the streaming to the cloud server 340 to be stored. Additionally, in another embodiment of the present disclosure, the image captured by the camera 200 can be directly transmitted to the cloud server 340 to be stored. For example, the image captured by the camera 200 can be directly transmitted to Facebook or Tudou, and thus other people can simultaneously view the image captured by the camera 200.

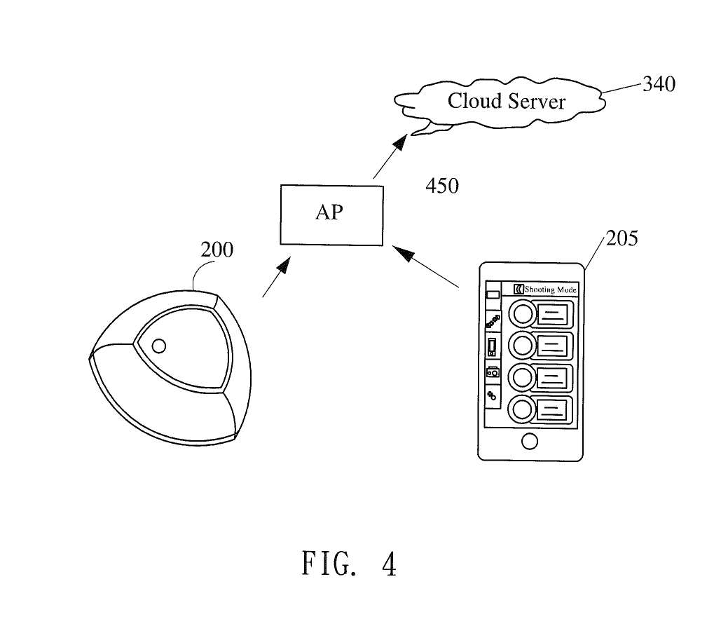

Please refer to FIG. 4. FIG. 4 is a diagram illustrating an interactive system that using a smart phone 205 to control a camera 200 according to a third embodiment of the present invention. In this embodiment, the smart phone 205 may remotely control the camera 200. The wireless network module 130 of the camera 200 is connected with an access point 450, and the smart phone 205 and the cloud server 340 can communicate with the access point 450 via network. The smart phone 205 can use the private application programming interface to store the image to the cloud server 340 via the access point 450, such that the image can be simultaneously viewed by lots of people. In another embodiment of the present disclosure, the smart phone 205 can use the private application programming interface to directly store the image to the cloud server 340, such that the image can be simultaneously viewed by lots of people.

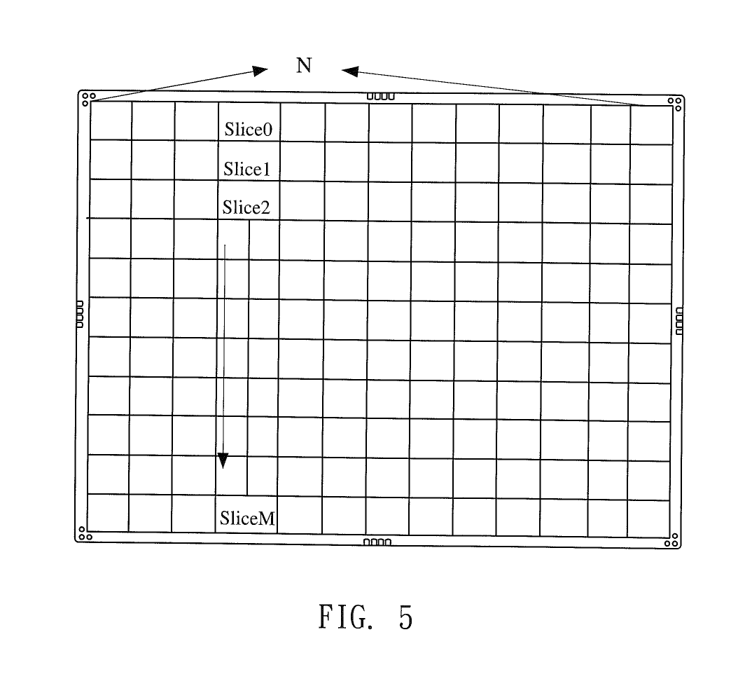

Please refer to FIG. 5. FIG. 5 is a diagram illustrating a video coding scheme that adopts a slice-based encoding method according to an embodiment of the present disclosure. As shown in FIG. 5, each image will be divided into M×N macroblocks (MB). In this embodiment, the slice-based encoding method adopts a row of macroblocks as a slice. That is to say, N macroblocks of each row are used for forming a slice, and thus the whole image will be divided into M slices. The encoder 120 may encode each slice, and then the wireless network module 130 may send out the encoded slices. After the encoded slices are received by the smart phone 205, the smart phone 205 may decode the encoded slices to be displayed on the smart phone 205. Another advantage of the present disclosure is that the encoder 120 does not need to contain an external DDR storage as buffer memory during encoding process. In addition, be compared to the prior art that adopts a microprocessor with its encoding software to encode images, the present disclosure, adopting a hardware component (an encoder) to encode images, has the advantages of low latency and low power consumption, which can improve the battery life of the camera 200 and can make it more smoothly to view image/video on the smart phone 205.

The advantage of the present disclosure is that the effect of low latency and low power consumption can be achieved during image transmission by using the video coding scheme, such that the battery life of the camera can be improved. By using the smart phone to control the camera, the size of the camera can be reduced. Therefore, the camera becomes more compact for convenient usage. Additionally, the smart phone may use the private application programming interface to store the image to the cloud server directly or via the smart phone, such that the image can be simultaneously viewed by lots of people. In other words, by adopting the conception of the present disclosure, some components of the camera, such as a memory card, a shutter button, and a display panel, can be omitted, which can greatly reduce the cost.

Those skilled in the art will readily observe that numerous modifications and alterations of the device and method may be made while retaining the teachings of the invention.

What is claimed is:

1. A camera controlled by using a smart phone, comprising:
a camera module, for capturing an image;
an encoder, coupled to the camera module, for encoding the image according to a video coding scheme to generate an encoded image; and
a wireless network module, coupled to the encoder and wirelessly communicating with the smart phone, for transmitting the encoded image to the smart phone to be displayed on the smart phone.

2. The camera according to claim 1, wherein the smart phone comprises a private application programming interface to control the camera; and the smart phone uses the private application programming interface to generate a control signal to adjust parameters including white balance and/or photographic intensity of the camera module, or control lens of the camera module to zoom in or zoom out the image.

3. The camera according to claim 2, wherein the smart phone uses the private application programming interface to store the image to a cloud server via the smart phone.

4. The camera according to claim 2, wherein the smart phone uses the private application programming interface to store the image to a cloud server.

5. The camera according to claim 1, wherein the wireless network module uses an access point mode for connecting with at least one smart phone.

6. The camera according to claim 1, wherein the wireless network module uses Wi-Fi Direct technology for establishing a point-to-point connection with the smart phone, so as to achieve a two-way interaction.

7. The camera according to claim 1, wherein the video coding scheme that adopts a slice-based encoding method, and the slice-based encoding method uses a row of macroblocks as a slice.

8. The camera according to claim 1, wherein the encoder does not contain an external DDR storage as buffer memory during the encoding process.

9. An interactive system that using a smart phone to control a camera, comprising:
a camera, comprising:
a camera module, for capturing an image;
an encoder, coupled to the camera module, for encoding the image according to a video coding scheme to generate an encoded image; and
a wireless network module, coupled to the encoder and wirelessly communicating with the smart phone, for transmitting the encoded image to the smart phone to be displayed on the smart phone; and
a cloud server;
wherein the smart phone comprises a private application programming interface, and uses the private application programming interface to store the image to the cloud server.

10. The interactive system according to claim 9, wherein the wireless network module uses an access point mode for connecting with at least one smart phone.

11. The interactive system according to claim 9, wherein the smart phone comprises a private application programming interface to control the camera; and the smart phone uses the private application programming interface to generate a control signal to adjust parameters including white balance and/or photographic intensity of the camera module, or control lens of the camera module to zoom in or zoom out the image.

12. The interactive system according to claim 11, wherein the smart phone uses the private application programming interface to store the image to a cloud server via the smart phone.

13. The interactive system according to claim 11, wherein the smart phone uses the private application programming interface to store the image to a cloud server.

14. The interactive system according to claim 9, wherein the wireless network module uses an access point mode for connecting with at least one smart phone.

15. The interactive system according to claim 9, wherein the wireless network module uses Wi-Fi Direct technology for establishing a point-to-point connection with the smart phone, so as to achieve a two-way interaction.

16. The interactive system according to claim 9, wherein the video coding scheme that adopts a slice-based encoding method, and the slice-based encoding method uses a row of macroblocks as a slice.

17. The interactive system according to claim 9, wherein the encoder does not contain an external DDR storage as buffer memory during the encoding process.
